(19) United States
(12) Patent Application Publication
(10) Pub. No.: US 2025/0322268 A1
(43) Pub. Date: Oct. 16, 2025

(54) User-Specific Knowledge Graph for Electronic Services

(71) Applicant: Samsung Electronics Co., Ltd., Suwon-si (KR)

(72) Inventors: Akash Sahoo, San Jose, CA (US); Aditya Jajodia, Sunnyvale, CA (US); Vijendra Raj Apsingekar, San Jose, CA (US)

(21) Appl. No.: 19/065,289

(22) Filed: Feb. 27, 2025

Related U.S. Application Data
(60) Provisional application No. 63/632,880, filed on Apr. 11, 2024.

(51) Int. Cl. G06N 5/022

(52) U.S. Cl. CPC G06N 5/022

(57) ABSTRACT

In one embodiment, a method includes accessing a communication between a user and an entity and identifying (1) each party to the communication and (2) one or more portions of the communication made by each identified party. The method further includes determining one or more contexts associated with the communication; generating an embedding of (1) the communication and (2) the one or more contexts in an embedding space; and updating a knowledge graph specific to the user, and accessible by an LLM associated with the user, with the embedding.

### PRIORITY CLAIM

This application claims the benefit under 35 U.S.C. § 119 of U.S. Provisional Patent Application No. 63/632,880 filed Apr. 11, 2024, which is incorporated by reference herein.

### TECHNICAL FIELD

This application generally relates to creating and using user-specific knowledge graphs for electronic services.

### BACKGROUND

People often communicate with entities, such as other people or businesses, using electronic communication methods. For example, phone calls provide electronic audio-based communication, and messaging services provide text-based communication methods. Many communication services allow communication using various types of electronic data, including audio, text, images, etc. Electronic communication requires input and attention from all communicating parties, unless a party's response is prerecorded, in which case that response is inflexible and typically not targeted to the specific incoming communication, and does not allow for specific follow-up communications without the party's input and attention. Electronic communication can therefore be disruptive, and often times repetitive.

A virtual assistant, also sometimes referred to as a digital assistant or an intelligent assistant, is a software agent that provides a range of task-performance and other human-assistance services, often in response to user input. For example, a voice assistant may receive verbal, spoken-word input from a user (e.g., to update a list, schedule a meeting, activate another device, place a call, and so), identify the user's goal from the input, and then identify and perform the tasks to achieve that goal. Virtual assistants often access a suite of specific agents, such as speech-to-text agents and AI agents including large-language models (LLMs), and other software applications such as weather applications, email applications, map applications, etc.

### BRIEF DESCRIPTION OF THE DRAWINGS

FIG. 1 illustrates an example method for creating a user-specific knowledge graph used to facilitate incoming or outgoing requests for the user.

FIG. 2 illustrates an example architecture and flow diagram for using a user-specific knowledge graph to facilitate communications for the user.

FIG. 3 illustrates an example computing system.

### DESCRIPTION OF EXAMPLE EMBODIMENTS

Examples of electronic communication include communication during real world-delivery services. Delivery persons or companies often require user-specific input from a user to make a successful delivery, such as by answering questions regarding the user's address, navigation to that address, access to the address (e.g., a gate code), etc. Last-mile delivery is often the most challenging part of a successful delivery, particularly in emerging and developing nations.

For instance, a delivery person may need to ask a customer for address assistance multiple times to make a delivery. Even with proper instruction the comprehension skills for different delivery are is different, and language barriers can also create complications for a successful communication in the delivery context. Similar challenges arise in hospitality and services-based industries, where customers ask similar questions again and again. In general, repeated queries between users and entities are a source of frustration. This includes multiple queries between communication participants (e.g., a delivery driver having to ask multiple questions about a particular delivery) and queries for repetitive information involving different participants (e.g., multiple delivery drivers asking for a code to open a gate, or multiple callers asking a hotel for today's pool hours). In addition, a successful communication sometimes requires a party to know the context associated with the other party, e.g., in order to provide accurate directions to a delivery person, a user needs to first know where the delivery person is,

Other challenges regarding electronic communications include an inability to provide follow-up information when recorded information is being provided (e.g., either no additional information is provided, or a call or message is sent to a human to respond); limited support for multiple languages; non-standardized address and ambiguous landmarks can often lead to confusion; and in some areas, digital maps or accurate addressing is suboptimal, making local landmarks or environmental knowledge more useful in navigation.

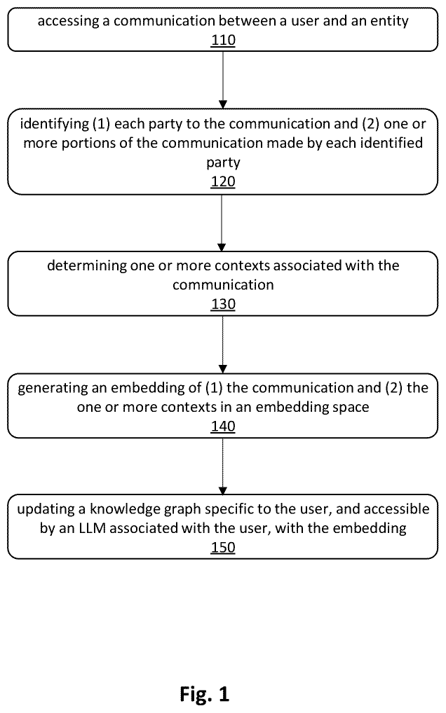

FIG. 1 illustrates an example method for creating a user-specific knowledge graph used to facilitate incoming or outgoing requests for the user. Step 110 of the example method of FIG. 1 includes accessing a communication between a user and an entity. Some or all of the steps of the example method of FIG. 1 may be performed by a virtual assistant, which may be executing on a client device of a user or on a server device. As explained more fully below, a virtual assistant may include a suite of modules and services that work together, one of which may be the example method of FIG. 1.

In particular embodiments, a user may be an individual and an entity may be another individual or a business or service provider. In other embodiments, a user may be a business/service provider and the entity may be another business/service provider or may be an individual. For instance, a user may be person who ordered a package, and the entity may be a delivery person delivering the package for a delivery company. As another example, the user may be a hotel, and the entity may be a person calling to inquire about hotel services (e.g., what hours the pool is open, etc.).

The communication may be a voice conversation (e.g., a phone call), a text communication (e.g., by SMS or a messaging service), or other communication. In particular embodiments, step 110 of the example method of FIG. 1 includes accessing the communication in at or near real time, i.e., while the communication is occurring. For instance, step 110 may include accessing an ongoing phone call or text communication between a user and a delivery person. In other embodiments, step 110 may include accessing a previous communication, e.g., accessing a text exchange that occurred or concluded prior to the access. In particular embodiments, accessing a communication may include including creating a record of the communication. For instance, a virtual assistant may record a communication (e.g., by transcribing the phone call). The record will typically be created on the user-side client device, i.e., on a client device of the user for whom the knowledge graph is created, as described more fully below.

Step 120 of the example method of FIG. 1 includes identifying (1) each party to the communication and (2) one or more portions of the communication made by each identified party. For instance, each party to the communication may be given a label in the communication. The label may include proper names (e.g., “John”) or may include a more arbitrary identifier (e.g., “party 1” or an alpha numeric string). The identifier may be a temporary identifier or a more permanent identifier (e.g., the same user/entity may be given the same identifier across multiple communications). In particular embodiments, the identity of a party to a communication may be determined based on the content of the communication, for example by using named-entity recognition, as described more fully below. In particular embodiments, the identity of a party to a communication may be determined based on information in a user's knowledge graph (e.g., based on contextual information, as described more fully below, or based on information from previous communications), or may be based on information in one or more other services that the user has given an assistant access to (e.g., a user's email inbox). If there are more than two parties to a communication, then each party may receive a unique identifier.

After each party to a communication is identified, then step 120 further includes identifying which portions of the communication are made by each party. For instance, in a phone call, the spoken conversation may be transcribed, and each portion of the transcription may be identified with one of the party identifiers. As another example, each portion of a text exchange may be identified by the party communicating that portion, using the party identifiers previously determined.

In particular embodiments, the method of FIG. 1 may include identifying named entities in the accessed communication. These named entities may include proper nouns (e.g., person or business names, streets names, etc.) and may include other identifier labels (e.g., landmark identifiers). In particular embodiment, a named entity may be particular to a specific user, e.g., may be a landmark that the particular user has previously identified.

In particular embodiments, named entities in a communication may be determined by an AI model, such as an LLM, trained at least in-part to identify named entities from communication input, typically text of the communication. For example, the LLM may be provided with the text of a communication and with a prompt instructing the LLM to identify named entities in the communication. Named entities may be determined from one or more named-entity databases, and a named-entity bias may be introduced (e.g., during a transcription process) to boost the identification of named entities. As used herein, named-entity biasing includes guiding a transcription towards named entities, for example based on previous communications (e.g., calls, texts, etc.) of the user. Named-entity databases may include general databases (e.g., collections of proper names, in the language used in the communication) and may include one or more named-entity databases specific to the user. For instance, a user's specific knowledge graph, discussed more fully below, may include embeddings of named entities used by or associated (e.g., through context) with that particular user, and these user-specific named entities may be boosted so that such named entities are more likely to be identified in communication involving that user (e.g., such named entities are given a higher probability when transcribing the communication). In particular embodiments, the user may have a personalized language model, for example as stored by or in association with a virtual assistant, and this personalized language model may include named-entity databases, some of which may be specific to that user. User-specific named entities may be persons the user identifies (e.g., family member names or co-worker names), businesses the user has identified or communication with, locations the user has identified or has been located at (e.g., through context), and so forth.

Named-entity recognition is an example of contextual biasing that more generally may be used to determine the content of a communication, e.g., to transcribe a phone call. For example, the transcription may be passed to an automatic speech-recognition module that biases output based on named entities and on contextual, environmental, and/or semantic factors related to the communication. The transcribed output (e.g., the text output by an LLM performing the verbal-to-text transcription) may then be rescored based on the biasing to determine the final transcription for the verbal communication.

Step 130 of the example method of FIG. 1 includes determining one or more contexts associated with the communication. As explained below, context may be determined implicitly or explicitly. Context may be determined separately from a particular communication or may be determined around or at the time of a communication.

Contexts can include information relevant to a user, such as a user's location, a user's typical places (e.g., a residence, a workplace, or more granularly such as a particular room being an office, a conference room, a kitchen, a living room, a bedroom, etc.), a user's associates (e.g., family members, friends, co-workers, and so on), and a user's possessions (e.g., a user's client devices, a user's electronic accounts or services, a user's vehicles, etc.). Context may be explicitly provided by a user for entry into the user's specific knowledge graph (explained more comprehensively later). For example, a user may enter context on an ad-hoc basis, e.g., by identifying to a virtual assistant that the user's current location is the user's home, workplace, favorite sandwich shop, etc. As another example, a user may provide a photograph of an item, e.g., a landmark or a vehicle, along with some information about that item (e.g., that the landmark is across from the user's house, that the vehicle is the user's daily driver, etc.). In particular embodiments, certain contextual information may be requested by a virtual assistant, e.g., during a setup phase or on an ongoing basis. In particular embodiment, a user may enter such information as the user desires or finds convenient.

In particular embodiments, context may be added in association with particular communications. For example, a user's location may be determined during a communication. As another example, during a conversation or after a conversation ends, a user can provide relevant information related to the communication, such as the user was communicating with a pizza delivery person, or that the user was calling a hotel that the user plans on staying at in 3 weeks as part of an upcoming ski trip. In particular embodiments, context may be automatically determined, e.g., from sensors (such as GPS sensors, a microphone, etc.) or from other services (e.g., an email provider) that the user grants access to. As explained below, once identified, context may be stored and used to facilitate subsequent communications between the user and an entity.

Step 140 of the example method of FIG. 1 includes generating an embedding of (1) the communication and (2) the one or more contexts in an embedding space. The embedding creation may be performed by an LLM, in particular embodiments. In particular embodiments, the communication and the context may be embedded together in the embedding space. For instance, if the context was determined at the same time as the communication or is specific to the communication (e.g., that the communication was for a delivery to the user's home address), then the two may be embedded together. Alternatively or additionally, context and a communication may be embedded separately from each during embedding, i.e., the communication and the context may be separately embedded. For instance, a communication may be embedded in the embedding space, and a context (e.g., added explicitly by the user prior to the communication) may be separately embedded, and these embeddings may be created at different times. In particular embodiments, embedding a communication or a context may include embedding features determined from that communication or context. For instance, a goal of the conversation may be extracted or determined, and this information may be embedded into the embedding space.

Step 150 of the example method of FIG. 1 includes updating a knowledge graph specific to the user, and accessible by an LLM associated with the user, with the embedding. In particular embodiments, the knowledge graph may be stored in the form of embeddings, e.g., may be the collective embeddings generated over time for the particular user in that embeddings space. The knowledge graph is user specific in that the graph and embeddings are private to the user, absent user permission otherwise. For example, the knowledge graph may be stored only locally on a client device of the user, such that none of the user-specific knowledge graph is stored on a server device. In particular embodiments, a user-specific knowledge graph may be transmitted to, or accessed by, multiple client devices of that user. For instance, a user profile associated with a user and with the knowledge graph (e.g., a user profile with a virtual assistant) may allow download of (and update to) the knowledge graph by each client device that the user is logged in to that profile on. Thus, the user can update their private, user-specific knowledge graph with communications from multiple client devices (e.g., smartphones, smart speakers, smartwatches, earbuds, smart appliances such as smart TVs, etc.) of that user. In particular embodiments, a knowledge graph may represent both the embeddings for the user over time and connections between those embeddings (e.g., represented by edges in the knowledge graph).

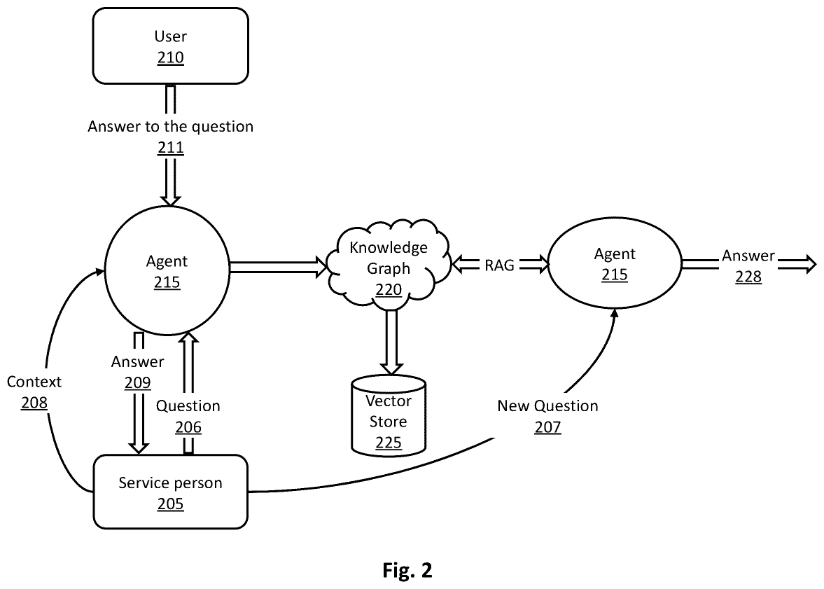

Once a knowledge graph is created for a user, that knowledge graph can be subsequently accessed to facilitate communication between the user and various entities. For instance, retrieval augmented generation (RAG) techniques may be used with the knowledge graph as a source of specific domain knowledge to fine-tune an LLM's response to an entity that requests information from the user. FIG. 2 illustrates an example architecture and flow diagram for using a user-specific knowledge graph to facilitate communications for the user. For instance, a service person (e.g., a delivery driver) 205 may request some information of user 210, e.g., through question 206. For instance, a delivery driver may have a question about the user's address, delivery preferences, etc. Typically such communications would go directly to the user and would require input from the user in order to resolve. However, as illustrated in FIG. 2, question 206 is first directed to agent 215. As explained above, context 208 related to the communication may likewise be provided to agent 215. Agent 215 then does two distinct things. First, agent 215 determines whether question 206 can be answered without input from user 210 by using information in user 210's knowledge graph 220. For instance, agent 215 may be a virtual assistant, and knowledge graph 220 may be stored on a client device of that user, along with embeddings represented in, for example, a vector store 225.

Agent 215 may access knowledge graph 220 via an LLM, which may be executed on the user's client device or on a server device associated with the agent. For example, an LLM may use RAG techniques to determine whether knowledge graph 220 of user 210 contains domain-specific information for answering question 206 from the service person 205. If yes, then agent 215 can directly provide answer 209 to service person 205, without invoking input from user 210.

In particular embodiments, agent 215 may require information from additional data sources other than knowledge graph 220 to fully answer question 206. Some of this information may be specific to user 210, and some may be more general. For example, a delivery driver asking whether the driver needs to access a gate code may depend on the time of day at which the delivery is being made, e.g., a code may be required after 7 μm, and thus agent 215 may determine the current time in order to fully answer question 206. As another example, a delivery person may ask whether the delivery address is a residence or a business, and agent 215 may determine such information from knowledge graph 220, and if not available, may look to other data sources, e.g., to a user's emails in order to determine which order the delivery pertains to (e.g., which order is associated with an email indicating that the delivery is that day's date) and then glean delivery-related information from the user's email. In particular embodiments, agent 215 may access maps, the internet, a user's email or other accounts, and the like in order to answer a specific question 206 and augment information in user-specific knowledge graph 220.

If agent 215 cannot answer question 206, then agent 215 may contact user 210 with question 206 or with a portion thereof that requires user input. User 210 may provide an answer 211, which is provided to agent 215. Agent 215 then determines answer 209 to the service provider from answer 211 or from a combination of answer 211, knowledge graph 220, and other data sources.

Question 206, answer 211 (if any) and context 208 are embedded and used to update knowledge graph 220. Thus, knowledge graph 220 can both be used to facilitate a specific communication between user 210 and an entity, and that facilitated communication is also used to update the knowledge graph for subsequent communications. As illustrated in FIG. 2, agent 215 can repeat the process described above to answer 228 a new question 207 from service person 205, which new question may be near in time to question 206 or may occur later (e.g., weeks or months later). Likewise, agent 215 repeats the process described above to answer subsequent questions from other entities.

Over time, a user's knowledge graph 220 may grow quite large, and therefore it may not be feasible to provide or access the entire graph during a RAG process to answer a particular question. Thus, in particular embodiments, portions of a graph may be retrieved (e.g., based on relevance, e.g., as determined by a distance between an embedded query and data in the embedding space) and ranked in order to determine an answer to a particular query.

In particular embodiment, a user may provide permissions for data in the knowledge graph and for accesses to other services by an agent. The permissions may be specific to a particular communication or entity, and may be specific to particular kinds of data in the knowledge graph. For example, a user may grant a particular application (or types of applications, e.g., food delivery applications) access to information about the user's addresses in the knowledge graph, but may not grant such access to other entities. Thus, the agent may either deny such a question from such entities, or may directly pass such questions to the user. In particular embodiments, permissions may be granted on a one-time basis or for a particular timeframe. For example, a user may permit a portion of their knowledge graph to be accessed by a particular entity (or by a particular application) once or for a particular period of time. The user may likewise grant access to their agent to access other data sources (e.g., the user's email), and may specify which entities, applications, and/or circumstances such data may be accessed and used to respond to questions.

A user's agent may be, for example, a virtual assistant that accesses various data sources, tools (e.g., LLMs), and sub-agents to provide services to the user. In particular embodiments, an agent may have different submodules (e.g., different sub agents) for different services, and these sub agents may have different permissions. An agent may have multi-modal capabilities, e.g., access to modules for accessing and interpreting information in maps, internet queries, applications on the user's client device(s), auto-fill capabilities, etc. In particular embodiments, for example as explained in connection with FIG. 2, an agent may determine whether a question requires accessing a user-specific knowledge graph (e.g., whether such user-specific information is required to begin with), whether permissions are needed and/or granted to access certain information, whether the knowledge graph contains the requested answer or whether the information in the knowledge graph must be augmented, and whether to ask the user for direct input to a particular query.

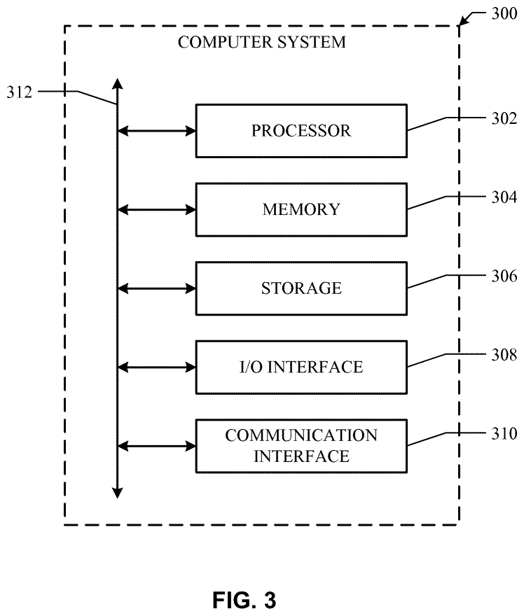

FIG. 3 illustrates an example computer system 300. In particular embodiments, one or more computer systems 300 perform one or more steps of one or more methods described or illustrated herein. In particular embodiments, one or more computer systems 300 provide functionality described or illustrated herein. In particular embodiments, software running on one or more computer systems 300 performs one or more steps of one or more methods described or illustrated herein or provides functionality described or illustrated herein. Particular embodiments include one or more portions of one or more computer systems 300. Herein, reference to a computer system may encompass a computing device, and vice versa, where appropriate. Moreover, reference to a computer system may encompass one or more computer systems, where appropriate.

This disclosure contemplates any suitable number of computer systems 300. This disclosure contemplates computer system 300 taking any suitable physical form. As example and not by way of limitation, computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 300 may include one or more computer systems 300; be unitary or distributed; span multiple locations; span multiple machines; span multiple data centers; or reside in a cloud, which may include one or more cloud components in one or more networks. Where appropriate, one or more computer systems 300 may perform without substantial spatial or temporal limitation one or more steps of one or more methods described or illustrated herein. As an example and not by way of limitation, one or more computer systems 300 may perform in real time or in batch mode one or more steps of one or more methods described or illustrated herein. One or more computer systems 300 may perform at different times or at different locations one or more steps of one or more methods described or illustrated herein, where appropriate.

In particular embodiments, computer system 300 includes a processor 302, memory 304, storage 306, an input/output (I/O) interface 308, a communication interface 310, and a bus 312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 302 includes hardware for executing instructions, such as those making up a computer program. As an example and not by way of limitation, to execute instructions, processor 302 may retrieve (or fetch) the instructions from an internal register, an internal cache, memory 304, or storage 306; decode and execute them; and then write one or more results to an internal register, an internal cache, memory 304, or storage 306. In particular embodiments, processor 302 may include one or more internal caches for data, instructions, or addresses. This disclosure contemplates processor 302 including any suitable number of any suitable internal caches, where appropriate. As an example and not by way of limitation, processor 302 may include one or more instruction caches, one or more data caches, and one or more translation lookaside buffers (TLBs). Instructions in the instruction caches may be copies of instructions in memory 304 or storage 306, and the instruction caches may speed up retrieval of those instructions by processor 302. Data in the data caches may be copies of data in memory 304 or storage 306 for instructions executing at processor 302 to operate on; the results of previous instructions executed at processor 302 for access by subsequent instructions executing at processor 302 or for writing to memory 304 or storage 306; or other suitable data. The data caches may speed up read or write operations by processor 302. The TLBs may speed up virtual-address translation for processor 302. In particular embodiments, processor 302 may include one or more internal registers for data, instructions, or addresses. This disclosure contemplates processor 302 including any suitable number of any suitable internal registers, where appropriate. Where appropriate, processor 302 may include one or more arithmetic logic units (ALUs); be a multi-core processor; or include one or more processors 302. Although this disclosure describes and illustrates a particular processor, this disclosure contemplates any suitable processor.

In particular embodiments, memory 304 includes main memory for storing instructions for processor 302 to execute or data for processor 302 to operate on. As an example and not by way of limitation, computer system 300 may load instructions from storage 306 or another source (such as, for example, another computer system 300) to memory 304. Processor 302 may then load the instructions from memory 304 to an internal register or internal cache. To execute the instructions, processor 302 may retrieve the instructions from the internal register or internal cache and decode them. During or after execution of the instructions, processor 302 may write one or more results (which may be intermediate or final results) to the internal register or internal cache. Processor 302 may then write one or more of those results to memory 304. In particular embodiments, processor 302 executes only instructions in one or more internal registers or internal caches or in memory 304 (as opposed to storage 306 or elsewhere) and operates only on data in one or more internal registers or internal caches or in memory 304 (as opposed to storage 306 or elsewhere). One or more memory buses (which may each include an address bus and a data bus) may couple processor 302 to memory 304. Bus 312 may include one or more memory buses, as described below. In particular embodiments, one or more memory management units (MMUs) reside between processor 302 and memory 304 and facilitate accesses to memory 304 requested by processor 302. In particular embodiments, memory 304 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 304 may include one or more memories 304, where appropriate. Although this disclosure describes and illustrates particular memory, this disclosure contemplates any suitable memory.

In particular embodiments, storage 306 includes mass storage for data or instructions. As an example and not by way of limitation, storage 306 may include a hard disk drive (HDD), a floppy disk drive, flash memory, an optical disc, a magneto-optical disc, magnetic tape, or a Universal Serial Bus (USB) drive or a combination of two or more of these. Storage 306 may include removable or non-removable (or fixed) media, where appropriate. Storage 306 may be internal or external to computer system 300, where appropriate. In particular embodiments, storage 306 is non-volatile, solid-state memory. In particular embodiments, storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 306 taking any suitable physical form. Storage 306 may include one or more storage control units facilitating communication between processor 302 and storage 306, where appropriate. Where appropriate, storage 306 may include one or more storages 306. Although this disclosure describes and illustrates particular storage, this disclosure contemplates any suitable storage.

In particular embodiments, I/O interface 308 includes hardware, software, or both, providing one or more interfaces for communication between computer system 300 and one or more I/O devices. Computer system 300 may include one or more of these I/O devices, where appropriate. One or more of these I/O devices may enable communication between a person and computer system 300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 308 for them. Where appropriate, I/O interface 308 may include one or more device or software drivers enabling processor 302 to drive one or more of these I/O devices. I/O interface 308 may include one or more I/O interfaces 308, where appropriate. Although this disclosure describes and illustrates a particular I/O interface, this disclosure contemplates any suitable I/O interface.

In particular embodiments, communication interface 310 includes hardware, software, or both providing one or more interfaces for communication (such as, for example, packet-based communication) between computer system 300 and one or more other computer systems 300 or one or more networks. As an example and not by way of limitation, communication interface 310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it. As an example and not by way of limitation, computer system 300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 300 may include any suitable communication interface 310 for any of these networks, where appropriate. Communication interface 310 may include one or more communication interfaces 310, where appropriate. Although this disclosure describes and illustrates a particular communication interface, this disclosure contemplates any suitable communication interface.

In particular embodiments, bus 312 includes hardware, software, or both coupling components of computer system 300 to each other. As an example and not by way of limitation, bus 312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 312 may include one or more buses 312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
accessing a communication between a user and an entity;
identifying (1) each party to the communication and (2) one or more portions of the communication made by each identified party;
determining one or more contexts associated with the communication;
generating an embedding of (1) the communication and (2) the one or more contexts in an embedding space; and
updating a knowledge graph specific to the user, and accessible by an LLM associated with the user, with the embedding.

2. The method of claim 1, wherein the communication comprises an audio communication.

3. The method of claim 2, further comprising generating a transcription of the audio communication, and wherein identifying one or more portions of the communication made by each identified party comprises identifying, for each portion of the transcription, a speaker of that portion.

4. The method of claim 1, wherein the knowledge graph specific to the user is stored locally on a client device of the user.

5. The method of claim 4, wherein the knowledge graph specific to the user is further stored locally on each of a plurality of client devices of the user.

6. The method of claim 1, further comprising identifying one or more named entities in the communication.

7. The method of claim 6, further comprising applying a named-entity bias to the communication.

8. The method of claim 1, wherein the LLM is part of a virtual assistant.

9. The method of claim 1, further comprising:
accessing a request for input from the user;
determining, at least in part by the LLM associated with the user, a response to the request based on the knowledge graph specific to the user.

10. The method of claim 9, further comprising requesting a response from the user based on a determination that the requested input is not satisfied by information in the knowledge graph specific to the user.

11. One or more non-transitory computer readable storage media storing instructions that are operable when executed to:
access a communication between a user and an entity;
identify (1) each party to the communication and (2) one or more portions of the communication made by each identified party;
determine one or more contexts associated with the communication;
generate an embedding of (1) the communication and (2) the one or more contexts in an embedding space; and
update a knowledge graph specific to the user, and accessible by an LLM associated with the user, with the embedding

12. A system comprising:
one or more non-transitory computer readable storage media storing instructions; and one or more processors coupled to the one or more non-transitory computer readable storage media and operable to execute the instructions to:
access a communication between a user and an entity;
identify (1) each party to the communication and (2) one or more portions of the communication made by each identified party;
determine one or more contexts associated with the communication;
generate an embedding of (1) the communication and (2) the one or more contexts in an embedding space; and
update a knowledge graph specific to the user, and accessible by an LLM associated with the user, with the embedding.

13. The system of claim 12, wherein the communication comprises an audio communication.

14. The system of claim 13, further comprising one or more processors operable to execute the instructions to generate a transcription of the audio communication, and wherein identifying one or more portions of the communication made by each identified party comprises identifying, for each portion of the transcription, a speaker of that portion.

15. The system of claim 12, wherein the knowledge graph specific to the user is stored locally on a client device of the user.

16. The system of claim 12, further comprising one or more processors operable to execute the instructions to identify one or more named entities in the communication.

17. The system of claim 12, further comprising one or more processors operable to execute the instructions to apply a named-entity bias to the communication.

18. The system of claim 12, wherein the LLM is part of a virtual assistant.

19. The system of claim 12, further comprising one or more processors operable to execute the instructions to:
access a request for input from the user;
determine, at least in part by the LLM associated with the user, a response to the request based on the knowledge graph specific to the user.

20. The system of claim 19, further comprising one or more processors operable to execute the instructions to request a response from the user based on a determination that the requested input is not satisfied by information in the knowledge graph specific to the user.
